(19) United States
(12) Patent Application Publication
(10) Pub. No.: US 2005/0267834 A1
(43) Pub. Date: Dec. 1, 2005

(54) Electronic Auction Loyalty and Incentive System using Demonstrated Contributions to Final Sell Price

(75) Inventor: Karl Douglas Zetmeir, Overland Park, KS (US)

Correspondence Address: Karl D. Zetmeir, 11909 Bluejacket, Overland Park, KS, 66213, US

(73) Assignee: Karl Douglas Zetmeir, Overland Park, KS (US)

(21) Appl. No.: 10/908,906

(22) Filed: May 31, 2005

Related U.S. Application Data
(60) Provisional application No. 60/575,518, filed on Jun. 1, 2004.

(51) Int. Cl. G06F 17/60

(52) U.S. Cl. 705/37

(57) ABSTRACT

This invention provides a system to correlate, accumulate and reward incentive points to Bidders in Online Electronic Auction venues. The invention recognizes milestones in Auction Listings and allows for the specific encouragement of bidding activity at each milestone. Further, this invention provides for the contribution made by each Bidder to the final price with every bid regardless of the amount. Incentive points are awarded based on a unique stair step alternating and reversing calculation between competitive Bidders and indexed by the Minimum Incremental Bid amount. The result is a fair and balanced distribution of incentive point allocations for Auction participants and enhanced bidding activity leading to higher bids as well as fewer listings receiving no bids.

### CROSS REFERENCE TO RELATED APPLICATIONS

This application claims the priority of Provisional Application 60/575518 Filed by Zetmeir on Jun. 1, 2004 and cross references Utility Patent Filing Ser. No. 10/905,528 Filed by Zetmeir on Jan. 7, 2005 incorporated by reference.

### BACKGROUND OF THE INVENTION

1. Field of the Invention

This invention relates to the establishment of a loyalty and activity incentive points system based upon the mathematical analysis and establishment of algorithms applied to individual transaction contributions to moving auction listings toward successful closes. The purpose is to increase the bidding and buying activities at the electronic auction site, increase the ultimate selling price of listed items sold to the benefit of Site Operators, Sellers and reward Bidders for their good faith efforts and time by recognizing and rewarding those efforts whether or not they are the successful winners of listings. Accumulated points may be redeemed for incentive products or services or donated by the individual to a charitable organization of his/her choice.

2. Discussion of Background

The popularity of online auctions over the past several years has grown dramatically, i.e. Ebay.com, Overstock.com, Bidville.com and others. Today there are hundreds of auction websites either for vertical lines of merchandise related to a specific trade or market as well a auction websites for horizontal lines of merchandise that are broad based and will accept virtually any merchandise and/or services from any Seller caring to post a listing . . . and bidding by the general public is welcome.

The popularity of electronic auctions is so great, “cracks in the wall” are beginning to appear. Often auction websites have become “buyers' markets” with many Sellers offering identical merchandise to too few Bidders. This has the effect of commoditizing goods and services where Sellers can only differentiate their listings by price.

The result of this online auction mania is many individual listings go through their auction cycles without so much as one bid. Current industry figures indicate fully 80-85% of all listings close without receiving a bid or reaching pre-determined “reserve” prices set by Sellers. This is disappointing as well as potentially expensive to Sellers as many auction websites charge a listing fee regardless of the eventual outcome of the listing.

On the other side of the auction, many Bidders are frustrated with current auction venues available as they may bid multiple times on listings over a time frame only to have the listings “sniped” by other Bidders who have only entered the bidding process in the last few seconds of a listing with a stated closing time. This has led many participants to leave electronic auction venues as they may seem “unfair.” Fully 50% of some websites' Registered Users are classified in their public financial reports as “inactive” or “disenfranchised.”

### PRIOR ART

European Filing WO 0129750 by Churchill, et al and assigned to Yahoo.com mentions, in a long laundry list of possibilities, the opportunity to earn points simply by bidding on listings. At no time does the filing provide a specific system or methodology for calculations of the point awards. This filing is also made in the U.S. as Ser. No. 09/422,114. Since no system is suggested regarding the calculations of points to be awarded, these are “one size fits all” suggestions. Clearly, auction listings run the gamut in terms merchandise and price. A one dollar bid increase in one listing is not equivalent to a twenty dollar bid increase in another.

During the mid nineties, several “dotcom” firms attempted to establish systems of “internet currencies.” Specifically, Beenz, Flooz, CyberCash and others awarded points for various consumer activities such as viewing ads, participating in questionnaires or other activities sponsors/clients were willing to award. At no time did these systems associate with online auction venues let alone provide a specific method of calculating points based on bid histories.

Another enterprise, NetZero, offered free internet access simply for viewing ads at their site. Clearly, there is nothing new, and nothing is claimed, relating to awarding incentives for viewer actions where they have no financial obligations resulting from the activity.

For many years, people have attended “Monte Carlo/Vegas Night” fundraisers. At those events people have the opportunity to win “funny money’ (points) at mock games of chance and then use those points to bid in a charity auction for items donated by generous benefactors. Again, this activity is unrelated to electronic online auction venues.

These incentive point “games of chance” formats are based upon the awarding of points only upon the conclusion of a given activity. They do not award points or “funny money” based upon the contribution a participant made solely for his/her activities whether or not they were the “winner” in the game of chance. Nor do participants make personal financial commitments, as they do in placing auction bids, in order to earn incentive points.

The points awarded may be exclusive to one auction website or generic and shared by multiple sites. Bidders may aggregate points from one or multiple sites for redemption, cash or merchandise, or donation to an organization or individual.

Upon receiving notification of points to be awarded, the points are placed in a “pending” file awaiting notification Sellers have been paid prior to releasing the points to Bidders and Buyers. The points accumulated in an individual's account may be suspended by a Site Operator for various infractions including, but not limited to, non-payment of a won listing.

### SUMMARY

The purpose of this invention is to provide a solution to the problems encountered by the three parties involved in electronic online auctions: Site Operators, Sellers and Bidders/Buyers. Operators need Sellers to be profitable for a continuation of an ongoing business relationship with them and extensive listings of goods and services Bidders find worthy of bid considerations. There is a three-way synergy between Site Operators, Sellers and Bidders. If there aren't enough Sellers with competitive listings, Bidders quickly disappear from the Operator's site and don't necessarily return. Without Bidders, Sellers are prone not to list their goods and services at sites that require effort and possibly expense regardless of the outcome thus reducing the Site Operator's profitability.

The intent of this invention is to provide a system of incentive points based on actual listing bid histories, the roadmap of each and every bid and its contribution to the final selling price.

It is not the intent of this invention to claim the invention of online electronic auctions. It is not the intent of this invention to claim the use of incentive and loyalty point systems to encourage and reward buyers. It is not even the intent of this invention to claim the possibility of rewarding Bidders in online electronic auctions with all Bidders receiving the same quantity of incentive points.

It is the intent of this invention to present a specific methodology that measures the exact contribution of each bid to the final outcome of a given listing and rewards Bidders and Buyers for their precise and demonstrated contribution to the final selling price which is documented in the bid history of the listing. Using points purchased from the Site Operator, Sellers have flexibility and input to the timing and quantity of points awarded which they may use to influence the outcome of their particular listings.

### BRIEF DESCRIPTION OF THE DRAWINGS

FIG. 1 shows an overview of how a User accesses the system through the Internet.

FIG. 2 is a Drawing of an auction listing where there is only one bid placed by one Bidder.

FIG. 3 is a Drawing of an auction listing with multiple bids and Bidders with no bid placed greater than the Minimum Incremental Increase set forth in the auction listing.

FIG. 4 is a Drawing of an auction listing with two Bidders, both of whom have placed a proxy bid.

FIG. 5 is a Drawing of an auction listing with three or more Bidders, each placing proxy bids.

FIG. 6 is a Drawing of the post-auction processing of point awards.

FIG. 7 is a spreadsheet representation demonstrating the mathematical calculations at three Auction Listing milestones.

### DETAILED DESCRIPTION OF INVENTION

This invention provides for the enhancement of an Online Electronic Auction venue by monitoring each and every bid made during the life of an Auction Listing, allowing Sellers to set individual listing and incentive point parameters and providing Bidders incentives for their participation in an auction listing whether or not they are the eventual winner of the Auction Listing.

Inherent to this system is the fact every bid, regardless of the amount, contributes to moving an auction along to its final selling price whether or not it is the Final Bid. Further, each progressive step calculation is controlled by the Minimum Bid Increase established by the Site Operator or Sellers offering listings.

In the preferred embodiment, the current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

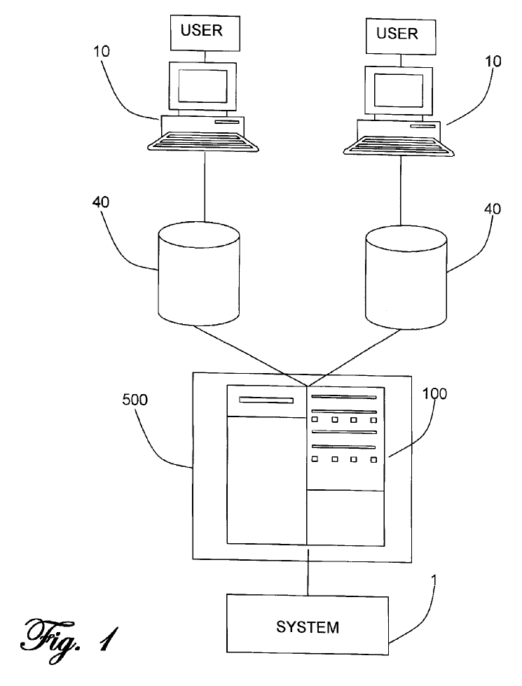

FIG. 1 illustrates a functional diagram of a computer network for World Wide Web access to the system 1 from a plurality of Viewers 10 to the Viewing web site 100. Accessing the system 1 can be accomplished directly through a communication means such as a local Internet Service Provider, often referred to as ISPs, or through an on-line service provider like CompuServe, Prodigy, American Online, etc.

The Users 10 contact the web site 100 using an informational processing system capable of running an HTML compliant Web browser such as Microsoft's Internet Explorer, Netscape Navigator, Lynx, Firefox and Mosaic. A typical system that is used is a personal computer with an operating system such as Windows 95, 98, 2000, XP or ME or Linux, running a Web browser. The exact hardware configuration of computer used by the Viewers 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

Preceding the interaction between Bidders and Sellers through the auction site is a structure that has been put in place by the Site Operator with rules and guidelines Sellers and Bidders must adhere to participate in the venue. Inherent in this structure is the understanding Sellers must award points acquired from the Site Operator to be awarded according to minimums set by the Site Operator to Bidders and Buyers. However, Sellers can exceed the minimums and exert control over how the incentive points are distributed as long as minimum standards are met. Further, it is understood the Site Operator will operate and administer the incentive point system. This entails the creation of a tracking and accounting system by Site Operators. The accounting system is a double entry system such that Sellers can access how and when incentive points were purchased from the Site Operator and when and which listings the points were awarded to Bidders and Buyers. Likewise, Bidders and Buyers can access whee they acquired incentive points and where and when they redeemed points they have won. This invention does not make any claims to double entry accounting, the basics of which are well known. However, within the accounting system Site Operators must establish a pending file capability such that Registered Users cannot bid on items only to accumulate points with immediate value with no regard or intention to pay for the items actually won. Or, in the event the winning Bidder refuses to pay for a won listing, all incentive points may be cancelled unless a secondary Bidder opts to accept the winning bid.

All incentive point valuations, considerations and awards are based upon and correlated to a detailed Bid History log file including each Bidder, the amount of their bids, the time and date of their bids. Points are awarded subsequent to the analysis of Bid Histories that are the roadmaps to every listing and its milestones.

Site Operators have ultimate control over the point award system and they may structure minimum standards, service, appeals and redemption programs as needed.

### DEFINITIONS

For the sake of accuracy, the following definitions are offered:

Online Electronic Auction: a venue on an electronic communication network bringing prospective Buyers and Sellers together such that Buyers might participate in a competitive venue to purchase merchandise and services from Sellers.

Registered Users: individuals who have applied and been accepted by a Site Operator for active participation in an Auction venue.

Sellers: individuals or entities who have applied and been accepted for active participation by a Site Operator to offer goods and services for sale in an Auction venue.

Site Operator: The entity managing the Auction website, providing guidelines, monitoring and other services to Registered Users and Sellers.

Auction Listing: an offering of goods or services by a Seller to Registered Users participating in an Auction venue.

Opening Bid: the minimum price a Seller will accept when offering an Auction Listing.

Interim Bids: all bids occurring between the opening bid and closing of an auction listing.

Final Bid: the last bid placed prior the end of an Auction Listing set forth as either a pre-determined time or a sequence of activity or non-activity, i.e. no further bids within one minute.

Minimum Bid Increase: the minimum dollar amount a Bidder may bid over and above a previous high bid. This is established by the Site Operator or the Sellers and may change as the Auction Listing progresses to its conclusion.

Reserve Price: an undisclosed price set by Sellers and registered with the Site Operator as the minimum acceptable price the Seller is willing to sell the Auction Listing items. Typically if the Reserve Price is not met, no sale is consummated.

Bid History: a detailed log of each and every bid made during the life of an Auction Listing. Every bid and Bidder is identified, the amount of their bids and the exact time of their bids.

Proxy Bid: a bid made in excess of what is necessary to become the immediate high Bidder. The remainder is held in reserve and only used if necessary to retain high Bidder status as other bids are made on the listing. The amount of the proxy bid is not disclosed to Bidders until the end of the Auction Listing when the entire Bid History is revealed.

### FUNCTONALITY

In most Auction Listings there are three distinct milestones in the progress of the listing. At each milestone, points determined by the Seller or Site Operators are awarded to Bidders and Buyers. The three milestones to be discussed below are Opening Bid, Interim Bids and Final Bid.

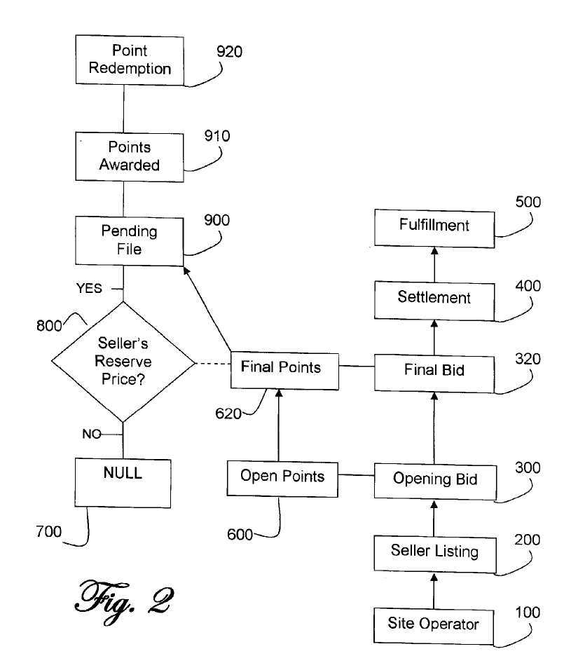

The first milestone is the Opening Bid. A block of points, determined by Sellers, generally within guidelines set by Site Operators, to be awarded to the first Bidder on a listing. Since there are no other Bidders at that exact moment in time, the points awarded are equal to the block of points set aside for this milestone. (FIG. 2)

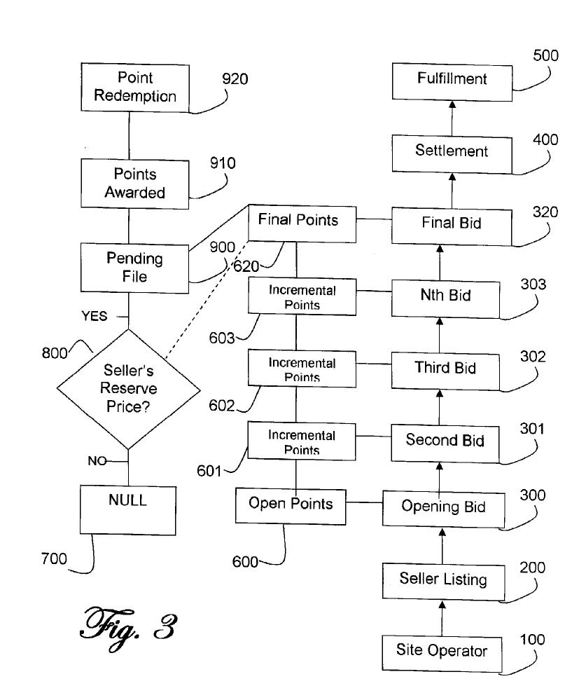

The second milestone is the interim bids. At the time of bid placement, a Bidder doesn't know whether or not his or her bid will be the final bid. If the previous high Bidder has not placed a proxy bid higher the bid shown, then the interim bid points are equal to the points allowed for a Minimum Bid Increase. (FIG. 3)

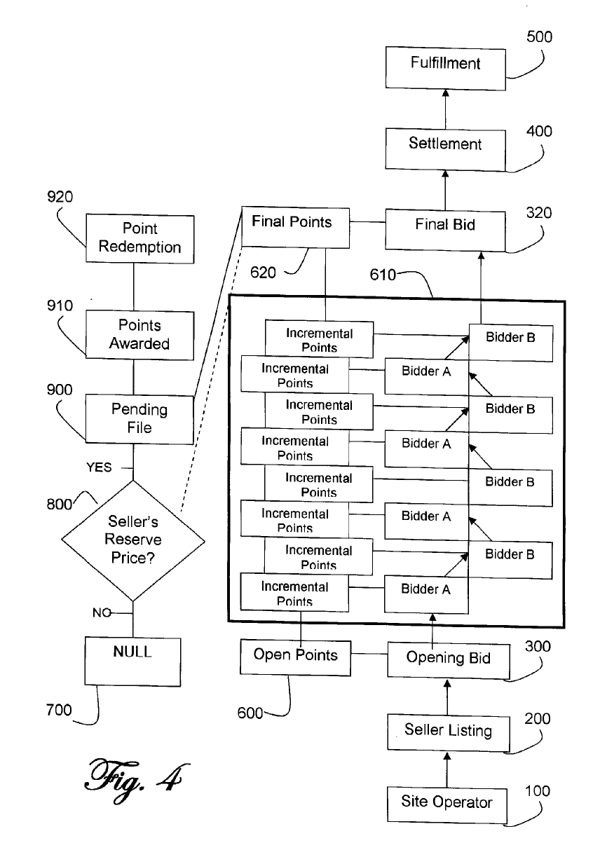

However, if the previous high Bidder placed a Proxy Bid, higher than necessary to maintain his/her high bid status, then a continuous stair-stepping and alternating calculation takes place to allocate and distribute incentive points between the two Bidders with the entry of the second Bidder. Each bid must be “tested” to see if it is the current high bid and whether or not it has met or exceeded the previous proxy bid. The testing continues until the higher of the two proxy bids is determined. In other words, the mathematical calculation switches back and forth with each progressive step determined by the Minimum Bid Increase. (FIG. 4, 610) In this way the contribution of each Bidder is accurately measured. Without the presence of the first Bidder and his/her proxy bid, the second Bidder does not move the valuation forward and vis a versa. Each has contributed, feeding upon the other and earning points for their contribution. Each step is equal to the Minimum Incremental Increase.

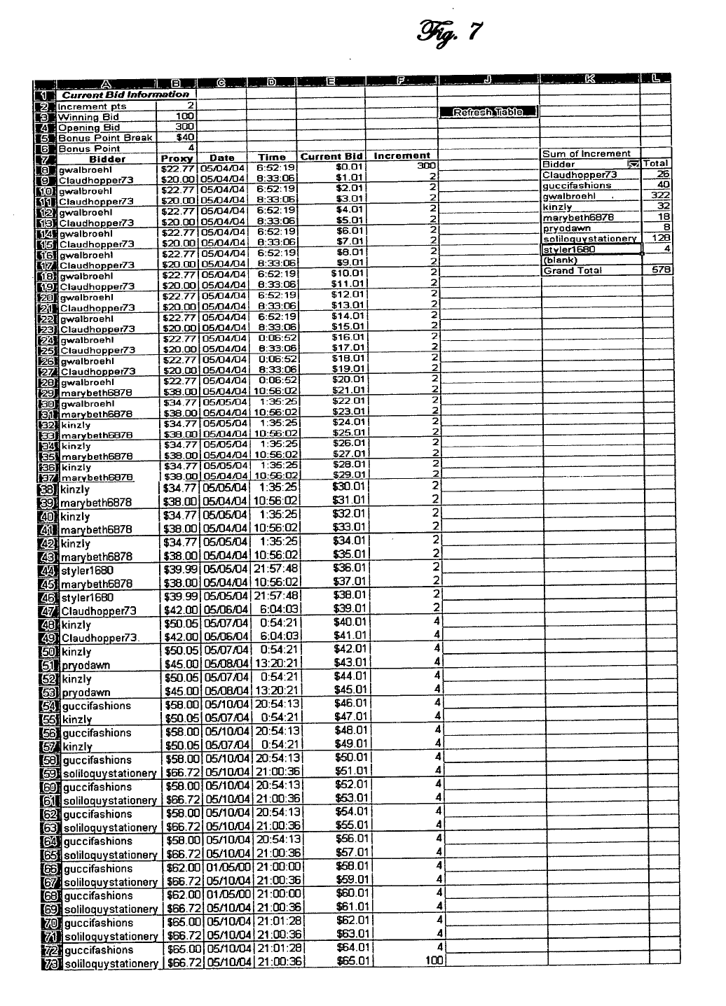

As a calculation, each new disclosed bid (NDB) is determined by the previous disclosed high bid (DHB) plus the minimum bid increase (MBI). DHB+MBI=NDB This simple calculation is repeated until the NDB exceeds the proxy bid placed by the competitive Bidder. In other words, Interim points are shared as both Bidders have contributed to moving the final valuation higher. This stair stepping progression is shown in spreadsheet FIG. 7. If desired, Sellers may increase the Interim Bid points per the Minimum Bid Increase during the listing to encourage higher and more frequent bidding.

In the third milestone, a block of points determined by the Sellers under guidelines of the Site Operator is awarded to the Final Bid. This is an incentive to push the listing's final valuation higher. If there is only one Bidder on a listing, then there are no interim bids and the Bidder receives both the Opening Bid block of points as well as the Final Bid block of points. At any point during the life of the listing, Sellers may increase the size of the block of points allocated to the winning bid.

If the Reserve Price set by a Seller is not met, the auction listing does not reach a successful conclusion negating the awarding of any and all points to Bidders.

### DISCUSSION OF DRAWINGS

In FIG. 1, as previously discussed, Users may access and interact with the Auction site through an electronic communications network such as the Internet.

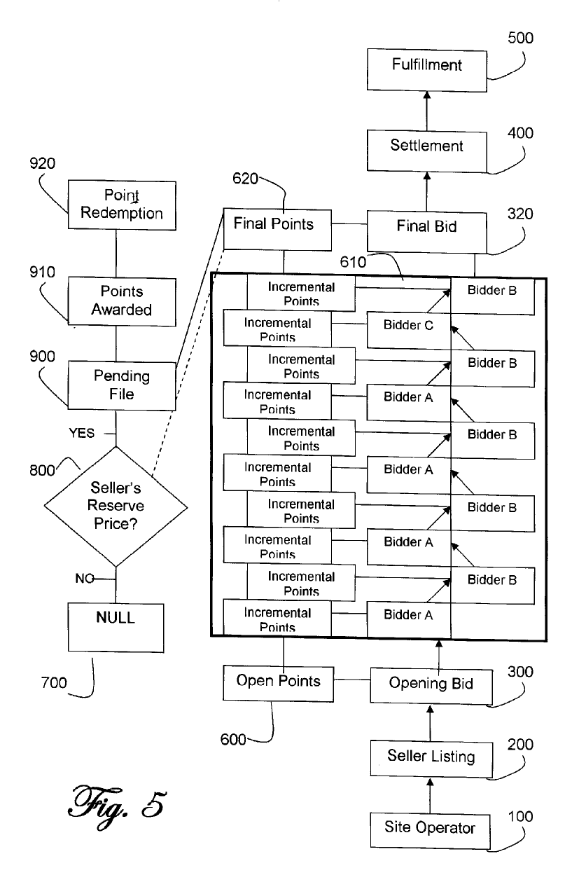

In FIG. 2, only one Bidder has participated in the listing (200). The Bidder makes both the Opening Bid (300) and the Final Bid (320) with one bid. The Bidder earns both the Open Points (600) and the Final Points (620) if there is no Seller's Reserve Price (800). If there is a Reserve Price, then the Final Bid must be compared to this Reserve Price to see if the Bid exceeds that amount. If it does not, then the Auction Listing is null (700) and the Auction Listing is voided and no points are awarded. If there was no Reserve Price, the points are awarded and move into a Pending File (900) to allow time for Settlement (400) and even Fulfillment (500) to occur before the points are released to Points Awarded (910) and ultimately Point Redemption by the Bidder (920). This post-listing processing (FIG. 5) as well as Settlement and Fulfillment is common to all drawings and it is unnecessary to repeat this follow through discussion on each drawing.

FIG. 3 represents an Auction Listing with multiple bids and Bidders. Each bid (301, 302, 303, 320) is equal to the Minimum Incremental Increase in dollars and the corresponding Incremental Point awards (601, 602, 603, 620). Each Bidder accumulates the points for each bid placed. At the Final Bid, the price is compared to the Seller's Reserve Price to determine if the listing exceeded that amount. If there is no Reserve Price, then the post-listing processing proceeds. The points are awarded based upon the listing log file that identifies every Bidder and their bids.

FIG. 4 (610) represents two Bidders, “A” and “B”, with Bidder “A” placing a Proxy Bid as the Opening Bid. Only enough money is used in his/her Proxy Bid to cover the Opening Bid price set by the Seller. With the entry of Bidder “B”, also entering with a Proxy Bid, a competitive comparative process begins to fairly award Incremental Points to each as well as determine which Bidder has the higher Proxy Bid. This calculation process is generally transparent to the Bidders and builds from the bottom up.

First the Minimum Incremental Increase is added to the Opening Bid of Bidder A (300) then compared to Bidder B's Proxy Bid. If Bidder B's Proxy Bid is higher, then a new high bid is established and Bidder B is awarded Incremental Points, then the new bid amount is compared to Bidder A's Proxy Bid. If Bidder A's Proxy Bid is higher still, then Bidder A is awarded Incremental Points, a new bid amount is set and compared again to Bidder B's Proxy Bid. This process of raising the bid by the Minimum Incremental Increase and awarding Incremental Points continues until one of the Bidders' Proxy Bids is determined to be the highest. In FIG. 4, the ultimate high bidder is Bidder B, who's last determined high bid is higher than Bidder A's Proxy Bid yet may be less than their own Proxy Bid and subsequently becomes the Final Bid. Both Bidder A and Bidder B have contributed to the Final Bid dollar value and without a second Bidder, the Final Bid would be identical to FIG. 2. It is therefore easy to see the Final Bid results from a competitive bidding process where each of the Bidders has contributed to the Final Bid and accumulates and receives incentive points relative to his or her contributions.

FIG. 5, (610) represents a similar listing as FIG. 4 except that additional Bidder “C” has also entered a bid. As the most recent competitive Bidders, the stair step calculations between Bidder A and Bidder B are completed before Bidder C is entered into the competitive bidding process. At that point, since Bidder B had the higher Proxy Bid compared to Bidder A, the competitive bidding calculation begins anew between Bidder C and Bidder B with each awarded incentive points according to their contribution to the Final Bid price. In the FIG. 5, again Bidder B has the higher Proxy and continues on to the Final Bid. However, clearly, additional multiple Bidders could have entered the process, yet the calculations remain the same. The comparisons are made between the two earliest Bidders before the same comparison is then made with the next Bidder chronologically youngest.

To encourage bidding on an Auction Listing, Sellers may choose to set plateaus in the incentive point award process. If the bidding passes a dollar point, the Incremental Points associated with the Minimum Bid Increase may be increased. If the bidding passes a certain dollar point, the Seller my opt to increase the block of incentive points in the block of Final Points to encourage last minute bidding and optimize the Auction Listing's profitability.

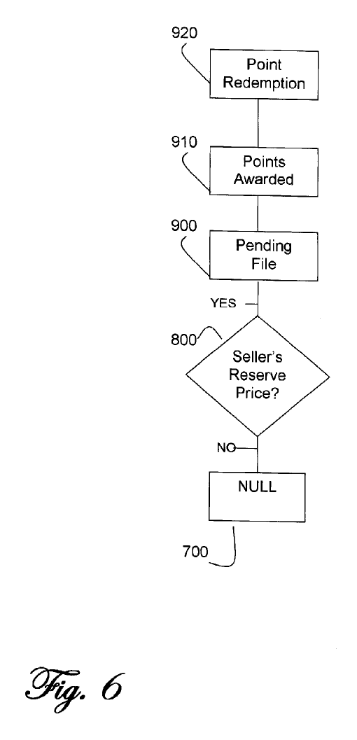

FIG. 6 is a breakout of the backend processing necessary for incentive point accounting, validation checks with Sellers' Reserve Prices (if any) and follow through by Sellers delivering the items listed.

FIG. 7 is a spreadsheet showing how different Bidders have contributed to moving the final price of an item to $65.01 from $0.01 and the points they have earned for their participation. Sellers can select milestone point valuations within Site Operator guidelines, change the values during the listing and set plateaus or Bonus Point Breaks where the Interim Incremental Points increase automatically as bidding reaches and exceeds those plateaus. In this example, clearly, “gwalbroehl” was most valuable to the Seller and earned 344 points even though not the eventual winner. “soliloquystationery” won the auction listing, but was not the major contributor in moving the Final Price forward in the opinion of the Seller who structured the milestone point valuations. Other Bidders also earned points based on their contributions.

While there are variations on auction formats and there are possible variations in point distribution methodologies, the core of this invention remains that each Bidder is rewarded based upon his or her contribution to the final selling price. Without the presence of competitive Bidders or the possibility of competitive bidding . . . the venue is simply a sale site and not an auction venue. This invention makes no claims regarding awarding incentive points for simply making a purchase.

1. A system for auctions;
having guidelines set by an Auction Site Operator to which Sellers and Registered Users are required to follow and having said Site Operator sell incentive points to said Sellers to be awarded to said Registered users.

2. A system according to claim 1 wherein said Site Operator sets minimums for the incentive points that must be awarded to Registered Users for their participation in Auction Listings based on the dollar value of the Auction Listing.

3. A system according to claim 1 wherein the correlating and awarding of incentive points is based on the Bid History.

4. A system according to claim 3 wherein bid history is stored in an Auction Listing log file.

5. A system according to claim 1 wherein having said Site Operator establish an incentive point accounting and control system.

6. A system according to claim 1 which includes establishing a Pending File system to place potential awarding of points in suspension until such time as payments by the Auction Listing winner is validated.

7. A system according to claim 2 which includes suspending incentive points to a registered user's account until the payment for said auction listing is made.

8. A system according to claim 1 which includes awarding points to Bidders based on their direct contribution to the final bid price of an Auction Listing.

9. A system according to claim 1 which includes associating Incremental Point values to dollar bid values.

10. A system according to claim 1 wherein awarding points to Bidders based upon the Minimum Incremental Bid established by Sellers.

11. A system according to claim 1 which includes accumulating incentive points for each Bidder based upon winning a particular incremental point step.

12. A system according to claim 1 which includes having a means to compare each successive bid, indexed by a Minimum Incremental Bid, with the previous high bid by a competitive Bidder.

13. A system according to claim 1 which includes having a means to compare each successive bid by a competitive Bidder with the Proxy Bid of the competitor.

14. A system according to claim 13 which includes having a means to repeat this process until it is determined which competitive Bidder has the higher Proxy Bid.

15. A system according to claim 1 which includes having a means to compare the final bid to the Seller's Reserve price to determine if any points should be awarded.

16. A system according to claim 1 which can be accessed through the Internet.

17. A system according to claim 1 which runs on a processing system.

18. A system for auctions;
having guidelines set by an Auction Site Operator to which Sellers and Registered Users are required to following and having said Site Operator sells incentive points to said Sellers to be awarded to said Registered users, where said Site Operator sets minimums for the incentive points that must be awarded to Registered Users for their participation in Auction Listings based on the dollar value of the Auction Listing, where the correlating and awarding of incentive points is based on the Bid History and said bid history is stored in an Auction Listing log file, where said Site Operator establish an incentive point accounting and control system which includes establishing a Pending File system to place potential awarding of points in suspension until such time as payments by the Auction Listing winner is validated where incentive points are suspended points to a registered user's account until the payment for said auction listing is made, which includes awarding points to Bidders based on their direct contribution to the final bid price of an Auction Listing, where Incremental Point values are associated to dollar bid values and awarded points to Bidders are based upon the Minimum Incremental Bid established by Sellers, where accumulated incentive points for each Bidder based upon winning a particular incremental point step, having a means to compare each successive bid, indexed by a Minimum Incremental Bid, with the previous high bid by a competitive Bidder, which includes having a means to compare each successive bid by a competitive Bidder with the Proxy Bid of the competitor repeating this process until it is determined which a competitive Bidder has the higher Proxy Bid and having a means to compare the final bid to the Seller's Reserve price to determine if any points should be awarded.

19. A system according to claim 18 which can be accessed through the Internet.

20. A system according to claim 18 which runs on a processing system.
